(19) United States
(12) Patent Application Publication
(10) Pub. No.: US 2008/0266735 A1
(43) Pub. Date: Oct. 30, 2008

(54) Method and Apparatus for Implementing APS Voltage Level Activation With Secondary Chip in Stacked-Chip Technology

(76) Inventors: Phil C. Paone, Rochester, MN (US); David Paul Paulsen, Dodge Center, MN (US); John Edward Sheets, Zumbrota, MN (US); Gregory John Uhlmann, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/739,723

(22) Filed: Apr. 25, 2007

(51) Int. Cl. H02H 3/20

(52) U.S. Cl. 361/86

(57) ABSTRACT

A method and apparatus implement adaptive power supply (APS) system voltage level activation eliminating the use of electronic Fuses (eFuses). A primary chip includes an adaptive power supply (APS). A secondary chip circuit includes at least one pair of hard-wired APS setting connections. Each hard-wired APS setting connection is defined by a selected one of a voltage supply connection and a ground potential connection. A respective inverter couples a control signal from each of the hard-wired APS setting connections to a power communication bus connected to the APS on the primary chip.

### FIELD OF THE INVENTION

The present invention relates generally to the data processing field, and more particularly, relates to a method and apparatus for implementing adaptive power supply (APS) system voltage level activation eliminating the need for using electronic fuses (eFuses).

### DESCRIPTION OF THE RELATED ART

Electronic fuses (eFuses) are one time electrically programmable elements that are written or blown with an external voltage that modifies the fuse resistance, allowing the fuse to retain its local state over time, powering on/off, and the like. Chip security is accomplished by blowing fuses at several stages of the product's design cycle including wafer test, module test, system test, lab use, customer use and returns.

Electronic Fuses (eFuses) are currently used to configure elements after the silicon masking and fabrication process. These fuses typically are used to configure circuits for customization and to correct silicon manufacturing defects and increase manufacturing yield.

However, reliability is a problem with using eFuses, for example, blowing of fuses can damage a portion of the chip. EFuses are blown in differing environments, for example, including temperature, voltage, life cycle, and the like. Containing damage cannot always be guaranteed under all operating conditions.

In blowing the eFuse elements, a particular blow current and typically an elevated voltage are required to accomplish blowing the eFuse. When a given eFuse is selected and blown, the current required to blow the eFuse can be measured at the pin used to deliver the eFuse blow voltage and the existence of an elevated voltage feeding the chip can enable would-be hackers to identify the location of the security on the chip.

Also it is a problem to reliably sense the state of the fuse or determine whether the fuse is blown or is it not. EFuses depend on a change of resistance when blown. This change in resistance can be relatively small and varies for individual fuse. This resistance change requires sensitive sense amplifiers that are becoming increasingly difficult to design and manufacture in shrinking technologies.

FIG. 1 illustrates a prior art eFuse circuit 100 including an eFuse 102 connected between a blow circuit 104 and a sense circuit 106. A pair of series connected inverters 108, 110 coupled to the sense circuit 106 provides an output of the eFuse circuit 100.

FIG. 2 illustrates a prior art adaptive power supply 200 including a chip 202 coupled to an adaptive power supply (APS) 204. A power communication bus 206 provides control signal to the APS 204 from the chip 202 utilizing, eFuse circuits 100 to select a power level for the chip 202, as indicated at a line labeled POWERLINE 208.

FIG. 3 illustrates exemplary power communication bus control signal values for exemplary system voltages levels of the prior art adaptive power supply (APS) 204 of FIG. 2. With a two-bit control signal input four predefined lowest system levels are selected. As shown with a control signal input of 00, for example, a predefined lowest system level in a range between 0.8 Volts (V) and 0.9 V is provided by the APS 204. As shown with a control signal input of 11, for example, the APS 204 provides a predefined highest system level in a range between 1.1 V and 1.2 V.

FIGS. 4A and 4B illustrate respective prior art eFuse boot steps and exemplary system voltages levels of the prior art adaptive power supply (APS) 204 of FIG. 2. First as indicated at a block 400, a power ramp step is provided, and the system voltage level of the prior art APS 204 increases from 0.0 V to 1.0 V, as indicated at a block 402. With the power-up at block 400, the voltage must ramp up to where all chips will function; however, this may cause low voltage chips to be discarded that fail to operate at the 1.0 V. An eFuse sense step is performed as indicated at a block 404, and the system voltage level of the prior art APS 204 is provided at about 1.0 V+\−0.5 V, as indicated at a block 406. An eFuse read step is performed as indicated at a block 408, and the system voltage level of the prior art APS 204 is provided at about 1.0 V+\−0.5 V, as indicated at a block 410. Next a power level output is provided as indicated at a block 412, and the system voltage level of the prior art APS 204 is provided at about 1.0 V+\−0.5 V, as indicated at a block 414. An APS read step is performed as indicated at a block 416, and the system voltage level of the prior art APS 204 is provided at about 1.0 V to the particular programmed voltage, as indicated at a block 418. Next a power re-supply step is performed as indicated at a block 420, and the system voltage level of the prior art APS 204 is provided at the particular programmed voltage, as indicated at a block 422. Finally a chip boot step is performed as indicated at a block 424, and the system voltage level of the prior art APS 204 is provided at the particular programmed voltage, as indicated at a block 426.

A need exists for an effective mechanism for implementing system voltage level activation for an adaptive power supply (APS), while eliminating the need for using electronic Fuses (eFuses).

### SUMMARY OF THE INVENTION

A principal aspect of the present invention is to provide a method and apparatus for implementing adaptive power supply system voltage level activation eliminating the need for using electronic fuses (eFuses). Other important aspects of the present invention are to provide such a method and apparatus for implementing adaptive power supply system voltage level activation substantially without negative effect and that overcome many of the disadvantages of prior art arrangements.

In brief, a method and apparatus are provided for implementing adaptive power supply (APS) system voltage level activation eliminating the use of electronic Fuses (eFuses). A primary chip includes an adaptive power supply (APS). A secondary chip circuit includes at least one pair of hard-wired APS setting connections. Each hard-wired APS setting connection is defined by a selected one of a voltage supply connection and a ground potential connection. A respective inverter couples a control signal from each of the hard-wired APS setting connections to a power communication bus connected to the APS on the primary chip.

In accordance with features of the invention, the secondary chip circuit includes a stacked chip arrangement. The secondary chip advantageously is produced using relatively inexpensive fabrication techniques and older technologies as compared to the primary chip. All eFuses conventionally used for APS system voltage level activation have been eliminated from the design of the primary chip, eliminating the need for blowing and sensing the eFuses. The secondary chip is configured to provide the desired APS system voltage level activation substantially immediately upon boot-up. There is no point during the system boot at which the system will be non-secure.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 illustrates a prior art eFuse circuit;

FIG. 2 illustrates a prior art adaptive power supply (APS);

FIG. 3 is a chart illustrating power communication bus control signal values for exemplary system voltages levels of the prior art adaptive power supply (APS) of FIG. 2;

FIGS. 4A and 4B are flow charts illustrating respective prior art eFuse boot steps and exemplary system voltages levels of the prior art adaptive power supply (APS) of FIG. 2;

FIG. 5 illustrates an adaptive power supply (APS) in accordance with the preferred embodiment;

FIGS. 6A and 6B are flow charts illustrating respective exemplary eFuse boot steps and exemplary system voltages levels of the adaptive power supply (APS) of FIG. 5 in accordance with the preferred embodiment;

FIG. 7 is a block diagram illustrating exemplary chip sorting for manufactured chips enabled with the adaptive power supply (APS) of FIG. 5 in accordance with the preferred embodiment.

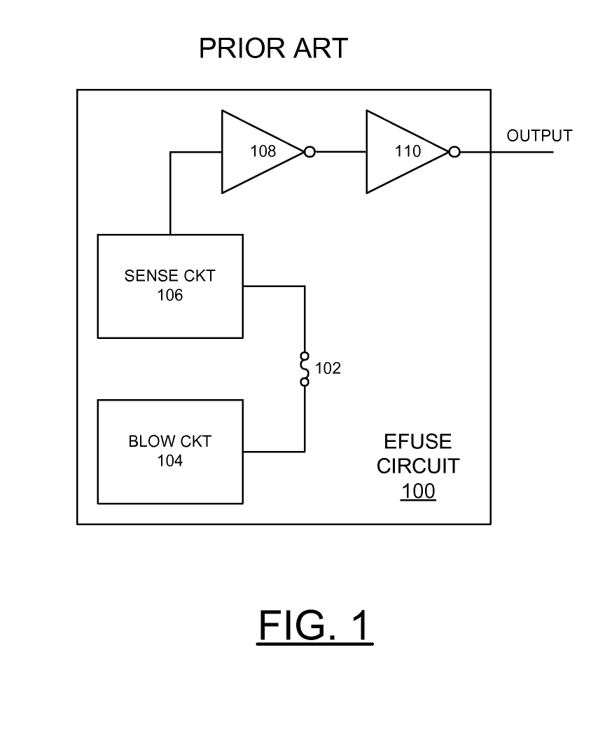

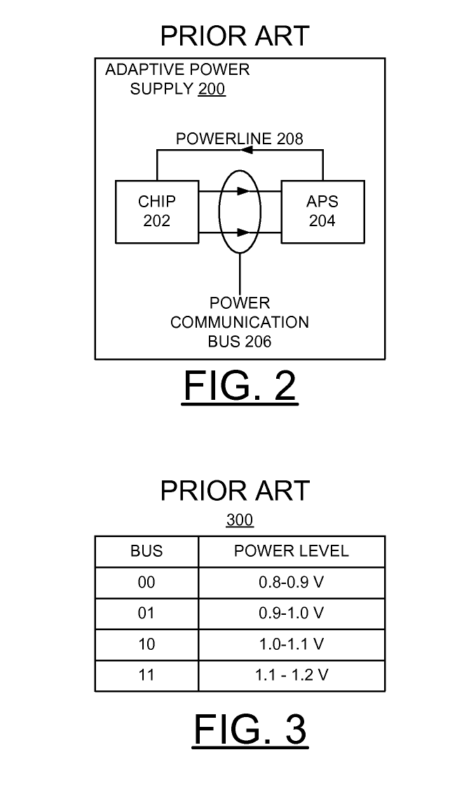

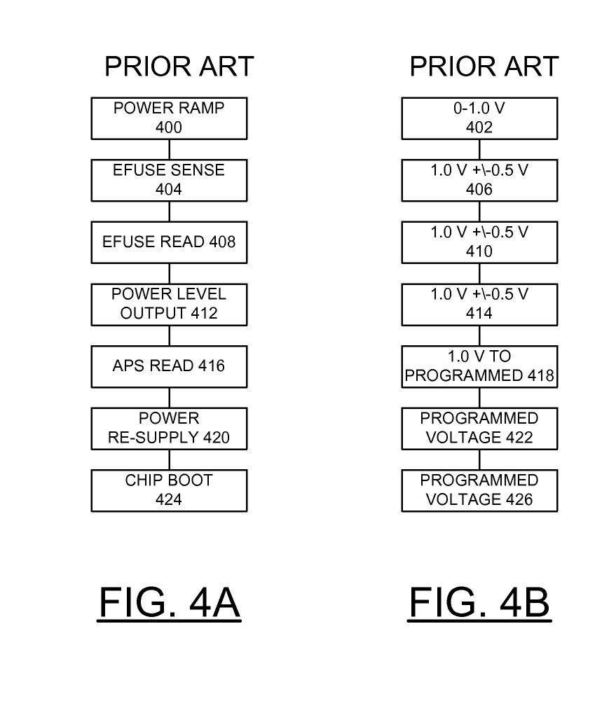

### DETAILED DESCRIPTION OF THE PREFERRED EMBODIMENTS

In accordance with features of the invention, using an Adaptive Power Supply (APS) in accordance with the preferred embodiment enables advantages in both power requirements and chip circuit yield. In the prior art APS systems, APS settings must first be read from respective eFuses before APS boot-up. In order to accomplish reading the APS settings from eFuses, a significant portion of the chip must boot-up with a common voltage. With APS settings connected directly to VDD or GND on a secondary chip in accordance with the preferred embodiment the boot process now ramps to VDD until the APS settings are recognized as ones and zeros. Once this has been accomplished the APS voltage is activated to the proper operating voltage.

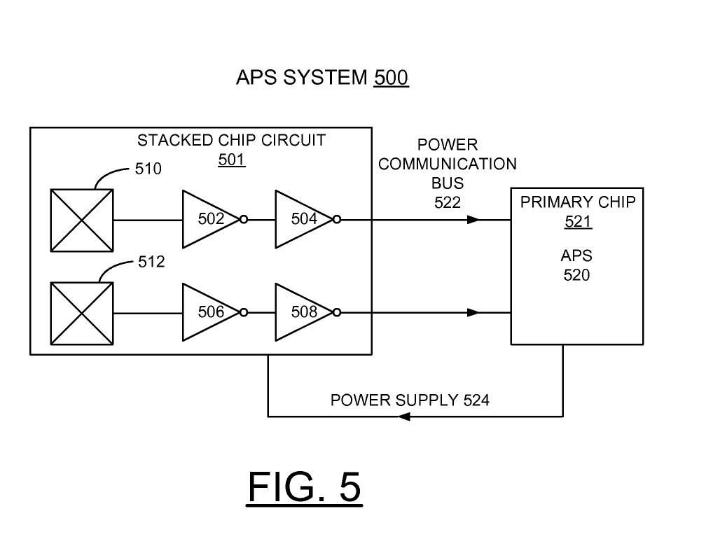

Having reference now to the drawings, in FIG. 5, there is shown an adaptive power supply (APS) generally designated by the reference character 500 in accordance with the preferred embodiment. APS system 500 includes a secondary chip stacked chip circuit 501. The secondary chip circuit 501 includes a pair of series connected inverters 502, 504; and 506, 508 respectively connected to one of a pair of hard-wired APS setting connections 510, 512. Each of the hard-wired APS setting connections 510, 512 is defined by a selected one of a voltage supply connection VDD and a ground potential connection. The respective output inverter 504, 508 couples a control signal from each of the hard-wired APS setting connections 510, 512 to an adaptive power supply (APS) 520 provided on a primary chip 521. A power communication bus 522 applies the control signal from each of the hard-wired APS setting connections 510, 512 to the APS 520 on the primary chip. The APS 520 provides a power supply 524 to the secondary chip circuit 501.

In accordance with features of the invention, the secondary chip circuit 500 includes a stacked chip arrangement. The secondary chip circuit 500 advantageously is produced using relatively inexpensive fabrication techniques and older technologies as compared to the primary chip APS 520. All eFuses conventionally used for APS system voltage level activation are eliminated from the design of the primary chip, eliminating the need for blowing and sensing the eFuses. The secondary chip circuit 500 is configured to provide the desired APS system voltage level activation immediately upon boot-up. There is no point during the system boot at which the APS system 520 will be non-secure.

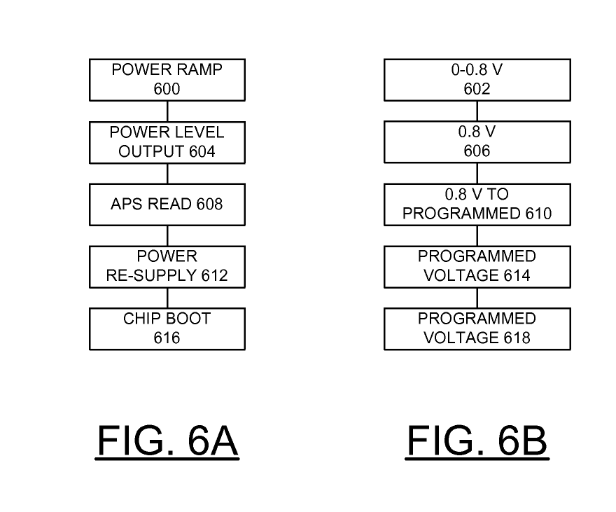

Referring now to FIGS. 6A and 6B, there are shown flow charts illustrating respective APS system boot-up steps and exemplary system voltages levels for the adaptive power supply (APS) system 500 in accordance with the preferred embodiment. The APS boot sequence is performed of each chip to provide a desired APS system voltage level activation for chip. First a power ramp step is provided to a first predetermined system voltage as indicated at a block 600, and the system voltage level of the APS 520 increases, for example, from 0.0 V to 0.8 V, as indicated at a block 602. The first predetermined system voltage advantageously is less than a system voltage level required for sense circuits to function on a conventional chip including eFuses. The inverters 502, 504; and 506, 508 respectively connected to the hard-wired APS setting connections 510, 512 are robust circuits that are functional at the first predetermined system voltage.

A power level output is provided as indicated at a block 604 and the first predetermined system voltage, such as 0.8 V, is provided by the APS 520 as indicated at a block 606. In a next APS system boot step, the APS 520 reads controls signals from the power communication bus 522 as indicated at a block 608, and as indicated at a block 610 the APS 520 ramps from the first predetermined system voltage to the programmed system voltage indicated by the control signals determined by the hard-wired APS setting connections 510, 512.

Next a power re-supply step is performed as indicated at a block 612, and the system voltage level of the APS 520 is provided at the particular programmed voltage, as indicated at a block 614. Finally a chip boot step is performed as indicated at a block 616, and the system voltage level of the APS 520 is provided at the particular programmed voltage, as indicated at a block 618.

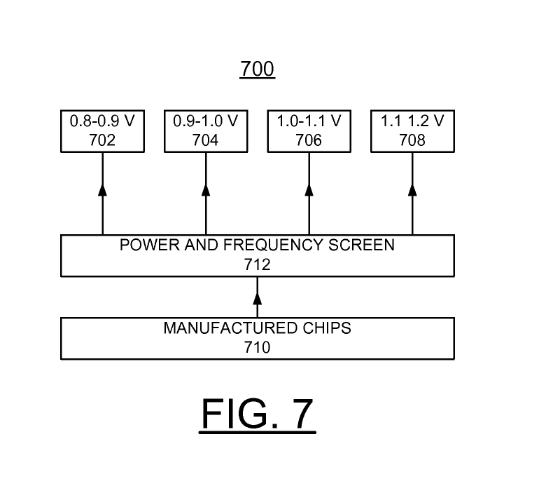

FIG. 7 illustrates chip sorting for manufactured chips enabled with the adaptive power supply (APS) system 500 in accordance with the preferred embodiment. The APS 520 provides multiple programmed voltage levels and manufactured chips are sorted into different voltage buckets as indicated at block 702, 704, 706, and 708. Chip testing of manufactured chips 710 is provided using a power and frequency screen 712 to determine a particular voltage buckets 702, 704, 706, and 708 for operating the chips. Then respective hard-wired APS setting connections 510, 512 for the respective sorted manufactured chips 710 are provided included with the secondary stacked chip circuit 501. Discarding fewer manufactured chips 710 is enabled with the APS system 500 since the chips are not required to function at the higher pre-boot voltages required for prior art eFuse sensing circuits.

While the present invention has been described with reference to the details of the embodiments of the invention shown in the drawing, these details are not intended to limit the scope of the invention as claimed in the appended claims.

What is claimed is:

1. Apparatus for implementing system voltage level activation for an adaptive power supply (APS) eliminating the use of electronic Fuses (eFuses) comprising:
a primary chip including an adaptive power supply (APS);
a secondary chip circuit including at least one pair of hard-wired APS setting connections;
each of said hard-wired APS setting connections being defined by a selected one of a voltage supply connection and a ground potential connection; and
a respective inverter coupling a control signal from each of said hard-wired APS setting connections to a power communication bus connected to said APS on said primary chip.

2. Apparatus for implementing system voltage level activation as recited in claim 1 wherein said secondary chip circuit includes a stacked chip arrangement with said primary chip.

3. Apparatus for implementing system voltage level activation as recited in claim 1 wherein said secondary chip is produced using relatively less expensive fabrication techniques as compared to said primary chip.

4. Apparatus for implementing system voltage level activation as recited in claim 1 wherein said primary chip only receives control signals from said secondary chip for APS system voltage level activation, eliminating eFuses conventionally used for APS system voltage level activation, and eliminating the need for blowing and sensing the eFuses.

5. Apparatus for implementing system voltage level activation as recited in claim 1 wherein said secondary chip provides control signals for APS system voltage level activation substantially immediately upon boot-up, eliminating a non-secure boot-up interval.

6. Apparatus for implementing system voltage level activation as recited in claim 1 wherein an APS system boot-up includes an initial power ramp to a first predetermined system voltage, said first predetermined system voltage being less than a system voltage level required for said primary chip to function.

7. Apparatus for implementing system voltage level activation as recited in claim 1 wherein said APS on said primary chip reads said control signal from each of said hard-wired APS setting connections, and activates a programmed system voltage level.

8. Apparatus for implementing system voltage level activation as recited in claim 1 wherein said secondary chip circuit includes a stacked chip arrangement with said primary chip, and said power communication bus providing a physically secure bus extending between said stacked chip arrangement.

9. A method for implementing system voltage level activation for an adaptive power supply (APS) eliminating the use of electronic Fuses (eFuses) comprising the steps of:
providing an adaptive power supply (APS) on a primary chip;
providing at least one pair of hard-wired APS setting connections on a secondary chip circuit;
defining each of said hard-wired APS setting connections by a selected one of a voltage supply connection and a ground potential connection; and
coupling a control signal from each of said hard-wired APS setting connections to a power communication bus connected to said APS on said primary chip.

10. The method for implementing system voltage level activation as recited in claim 9 includes providing a respective inverter to drive said power communication bus.

11. The method for implementing system voltage level activation as recited in claim 9 includes providing a stacked chip arrangement for said secondary chip circuit with said primary chip.

12. The method for implementing system voltage level activation as recited in claim 9 includes producing said secondary chip using relatively less expensive fabrication techniques as compared to said primary chip.

13. The method for implementing system voltage level activation as recited in claim 9 includes providing said primary chip to only receive control signals from said secondary chip for APS system voltage level activation, eliminating the use of eFuses for APS system voltage level activation from said primary chip, and eliminating the need for blowing and sensing the eFuses.

14. The method for implementing system voltage level activation as recited in claim 9 includes providing control signals for APS system voltage level activation substantially immediately upon boot-up with said secondary chip, eliminating a non-secure boot-up interval.

15. The method for implementing system voltage level activation as recited in claim 9 includes providing an APS system boot-up including an initial power ramp to a first predetermined system voltage, said first predetermined system voltage being less than a system voltage level required for said primary chip to function.

16. The method for implementing system voltage level activation as recited in claim 15 includes providing an APS read of said power communication bus responsive to a power level of said first predetermined system voltage.

17. The method for implementing system voltage level activation as recited in claim 9 includes reading said control signal from each of said hard-wired APS setting connections with said APS on said primary chip, and activating a programmed system voltage level with said APS on said primary chip.

18. The method for implementing system voltage level activation as recited in claim 9 includes providing a stacked chip arrangement of said secondary chip circuit with said primary chip, and providing a physically secure bus with said power communication bus extending between said stacked chip arrangement.
